(19) United States
(12) Patent Application Publication
(10) Pub. No.: US 2010/0038410 A1
(43) Pub. Date: Feb. 18, 2010

(54) SECURING METALLIC OBJECTS

(76) Inventors: Patrick Anthony McHale, Doncaster (GB); Roger Alexander Black, Retford (GB); Paula Margaret Madelaine Dewsnap, York (GB)

Correspondence Address: KLARQUIST SPARKMAN, LLP, 121 SW SALMON STREET, SUITE 1600, PORTLAND, OR, 97204, US

(21) Appl. No.: 12/531,046

(22) PCT Filed: Mar. 10, 2008
(86) PCT No.: PCT/GB08/00825

§ 371 Date: Sep. 11, 2009

(30) Foreign Application Priority Data
Mar. 13, 2007 (GB) 0704817.6

(51) Int. Cl. B23K 31/02; B23K 37/00; B23K 37/04; B23K 28/00

(52) U.S. Cl. 228/194; 228/56.5; 228/44.3; 219/617

(57) ABSTRACT

A method and apparatus are disclosed for securing a first metallic target object to a further metallic target object. The apparatus includes a heating element for heating a bonding interface region between juxtaposed portions of a first and further metallic target object, at least one chamber body portion securable around the interface region to form a chamber region surrounding the interface region, a pump member for at least partially removing oxygen from the chamber region and a target object locating unit arranged to locate portions of the first and further target objects in a juxtaposed position.

The present invention relates to a method and apparatus for securing metallic objects such as rails, of the type from which a railway can be constructed, together. In particular, but not exclusively, the present invention relates to a method and apparatus for bonding adjacent ends of two rail sections together in an end-to-end configuration using a liquid phased diffusion bonding process.

The construction of a railway formed of a pair of spaced apart parallel rails is well known. Each of the rails are typically formed from a carbon steel material and typically are provided by long lengths of rail sections up to 216 metres long or even longer which are secured together end-to-end. It is well known that the process by which adjacent rail lengths are secured together is of importance both from a security/safety and cost point of view. As will be appreciated, trains often carrying many human passengers or valuable freight constantly pass over the joins in sections of the rails and the joins must therefore perform well under adverse environmental effects and over prolonged periods of times so as to avoid injury to people or damage to valuable goods. A particular problem which often occurs when utilising known methodologies for securing rail sections together is that the join is not 100% reliable and is subject to failure. Further problems exist when known methodologies consume rail as part of the process so that they can not be used on joins to ‘close’ the rail to existing track. The known methodologies are also time consuming and expensive.

In order to overcome such problems, various techniques have been developed for joining rail sections together and various industry standards have been set to determine a quality of join which must be satisfied. For example, the method for joining rail has remained relatively unchanged within the UK for decades with the process that dominates being the Alumina Thermit process. A process referred to as flash butt welding has been proposed, however such a process involves a number of disadvantages as will be appreciated by those skilled in the art.

It is an aim of the present invention to at least partly mitigate the above-mentioned problems.

It is an aim of embodiments of the present invention to provide a method and apparatus for securing metal objects together.

It is an aim of embodiments of the present invention to provide apparatus and a method for bonding a first rail member to a further rail member so as to provide rail sections bonded end-to-end with a bond formed at a join between the rails which satisfies industry standards and which can be efficiently and repeatedly formed on site.

It is an aim of embodiments of the present invention to provide apparatus and a method for bonding rails together at a work site where the rails are to be laid.

According to a first aspect of the present invention there is provided apparatus for securing a first metallic target object to a further metallic target object, comprising:
a heating element for heating a bonding interface region between juxtaposed portions of a first and further metallic target object;
at least one chamber body portion securable around the interface region to form a chamber region surrounding the interface region;
a pump member for at least partially removing oxygen from the chamber region; and
a target object locating unit arranged to locate portions of the first and further target objects in a juxtaposed position.

According to a second aspect of the present invention there is provided a method for securing a first metallic target object to a further metallic target object, comprising the steps of:
inserting an insert element at a bonding interface between juxtaposed portions of first and second metallic target objects;
applying pressure to said bonding interface;
at least partially removing oxygen from a region surrounding said bonding interface;
heating said region to thereby secure said target objects via a diffusion bonding process.

Embodiments of the present invention provide an apparatus and a method capable of delivering improved strength joints between rail sections compared to similar joints formed by known techniques. In addition, embodiments of the present invention provide a method by which rail sections can be bonded together in shorter timescales and with a much lower rejection rate than when using prior known techniques.

Embodiments of the present invention provide a railbond system able to replicate a Transient Liquid Phase Diffusion Bonding (TLPDB) process within a mobile unit which is capable of accessing the rail infrastructure and producing a strong, good quality bond on the track in working site conditions.

Embodiments of the present invention will now be described hereinafter, by way of example only, when considered in the light of the accompanying drawings, in which:

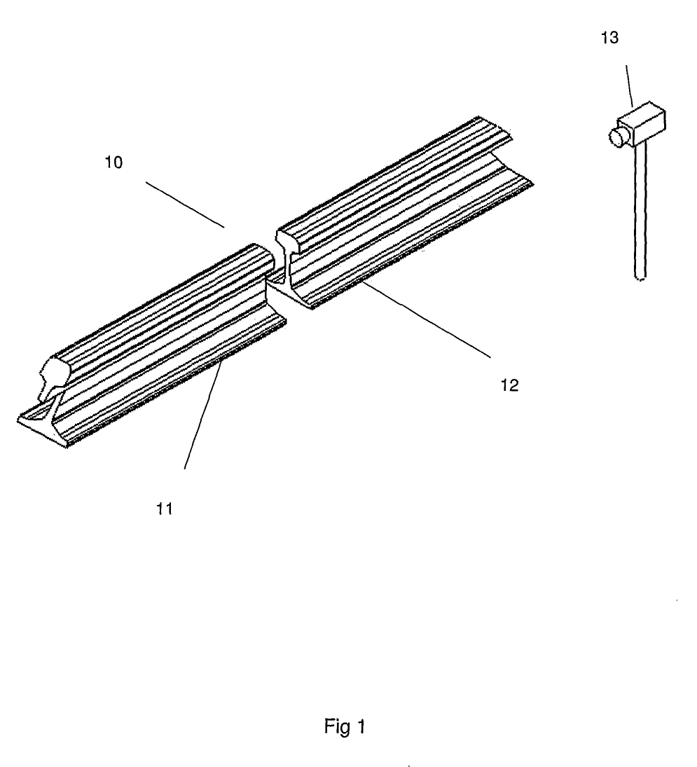

FIG. 1 illustrates a track side work site;

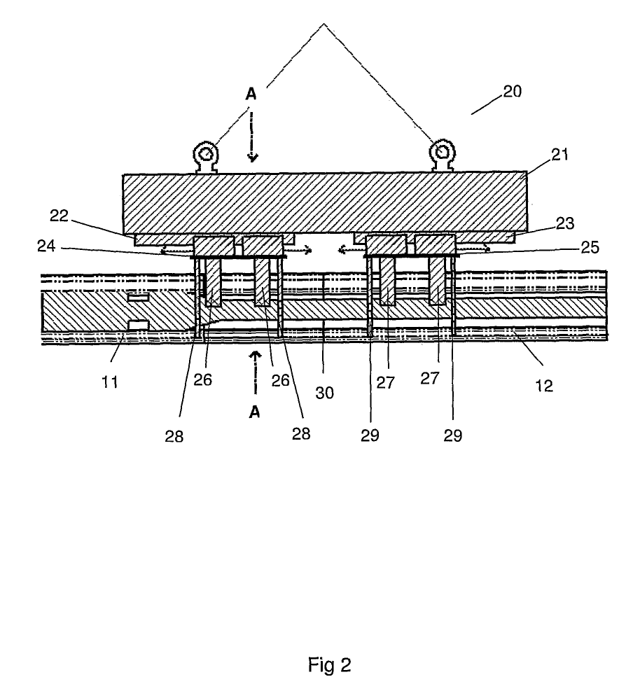

FIG. 2 illustrates a rail alignment mechanism;

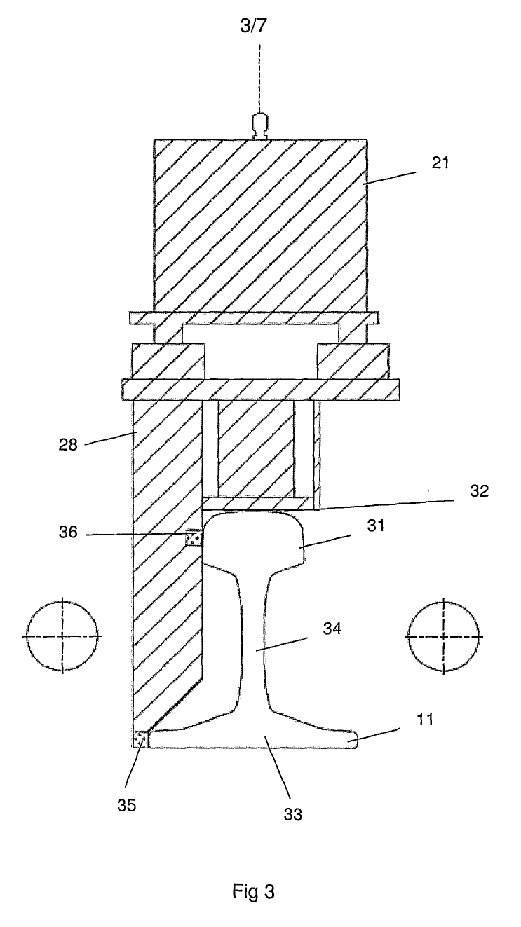

FIG. 3 illustrates a cross sectional view of the rail alignment mechanism;

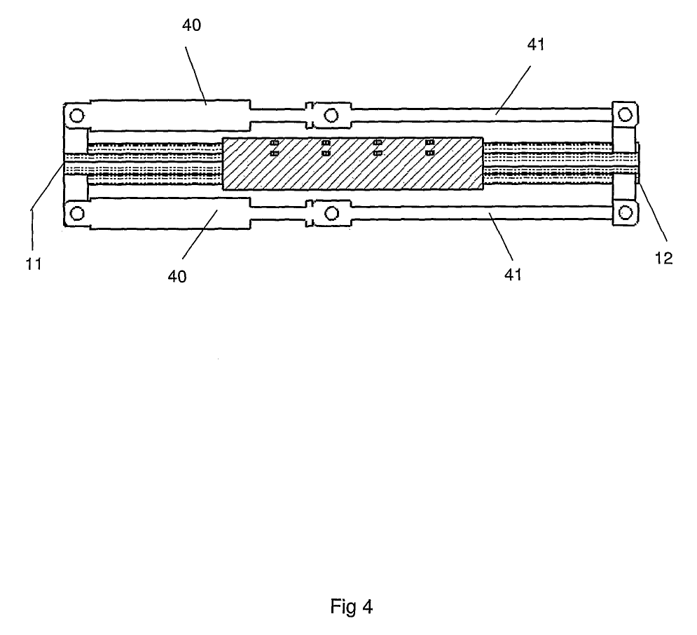

FIG. 4 illustrates parts of the rail alignment mechanism;

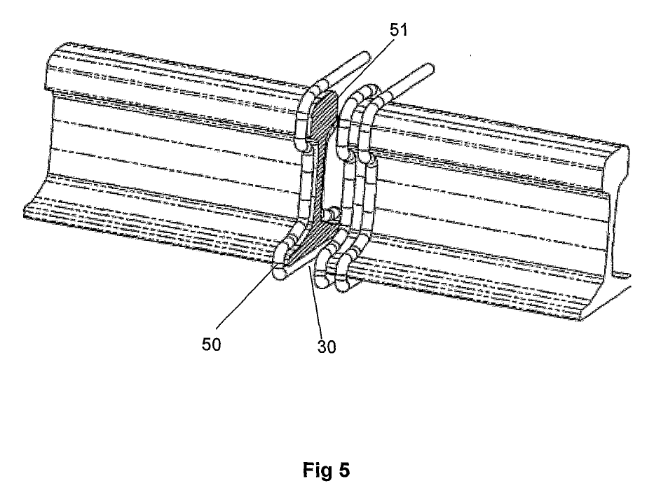

FIG. 5 illustrates a heating coil at a bonding interface;

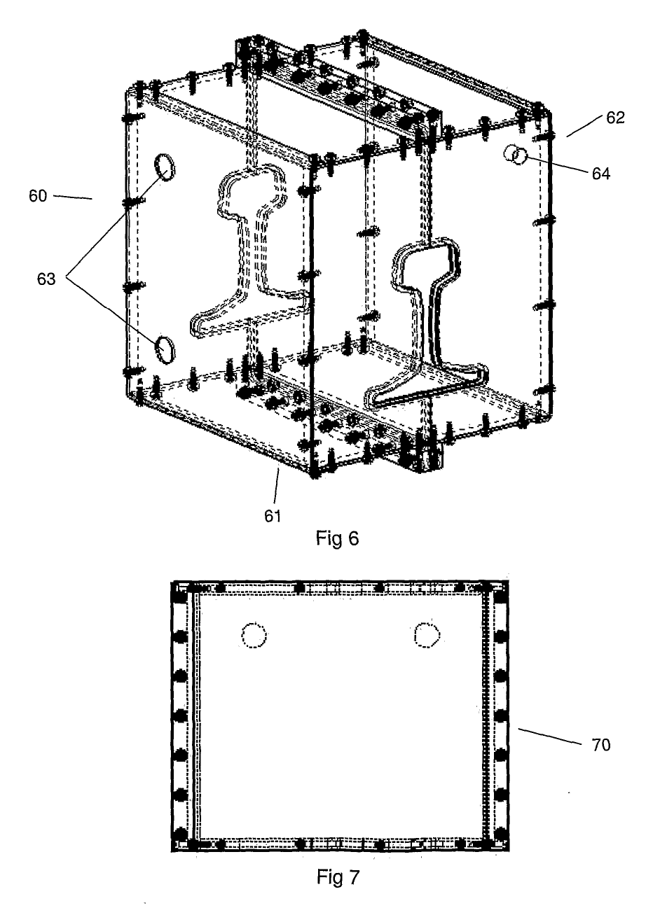

FIG. 6 illustrates a gas box;

FIG. 7 illustrates a side wall of the gas box; and

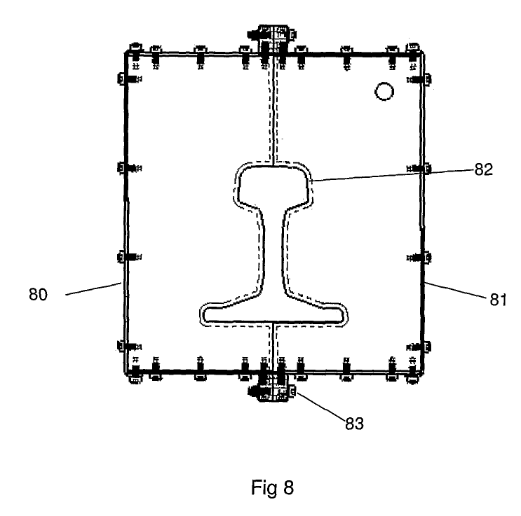

FIG. 8 illustrates an end of a gas box.

In the drawings like reference numerals refer to like parts.

Embodiments of the present invention utilise a process known as Transient Liquid Phase Diffusion Bonding (TLPDB) to bond together adjacent sections of rail in an end-to-end configuration. The process utilises an amorphous metal braze foil that contains additions of Silicon (Si) and Boron (B). For example a sheet of Nickel-based brazing foil such as Metglas® MBF-51 as obtainable from www.metglas.com can be used. Other types of brazing foil may be used as will be appreciated by those skilled in the art. The foil is placed between two juxtaposed faces formed at the ends of adjacent rail sections and heat and a pressure are applied. Once above the liquidus temperature of the foil material, melting occurs causing rapid diffusion of Silicon and Boron into the parent material of the adjacent rails. As this diffusion occurs the liquid phase re-solidifies producing a bond that is as strong, if not stronger, than the parent material of the adjacent rail sections. Embodiments of the present invention are able to replicate this process via a mobile unit such as a vehicle which is capable of accessing the rail infrastructure and producing a strong, good quality bond on the track in work site conditions. The mobility of the vehicle and process is advantageous so that the bonding can be undertaken in “field” conditions for use within renewals or maintenance of rail infrastructure.

FIG. 1 illustrates a work site where it is desired to secure together ends of adjacent rail sections 11, 12 in an end-to-end configuration. The location 10 will typically be at a desired location where a track formed by parallel spaced apart rails are located with the rails being supported by sleepers and ballast as will be appreciated by those skilled in the art. It will be appreciated that embodiments of the present invention are not restricted to the bonding of rail elements but are more generally applicable wherever a first metallic target object is to be secured to a further metallic target object.

Prior to bonding the site 10 where renewals/maintenance is to be carried out is identified. Site details may be recorded such as rail type to be bonded.

Subsequent to identification of the site a mobile vehicle, such as a road vehicle or rail vehicle, is collected from a depot and equipped with necessary parts such as gas, spare inserts and seals. The vehicle will then travel to the work site either via a road and/or rail network. Embodiments of the present invention can optionally be utilised to bond together only one or a few adjacent rail sections or can be utilised repeatedly along a length of track to lay a rail. If only one join is to be made the vehicle is brought proximate to that join. If more than one consecutive join is to be made the vehicle is provided at the first join in the series of joins.

Once at a desired location a rail alignment mechanism 20, illustrated in FIG. 2, is lowered from the vehicle and placed on an existing section of track using the top and sides of the existing track as datum point for locations. It will be appreciated that when utilising embodiments of the present invention without extant rail track other datum points will be supplied so as to ensure accurate location of the rail alignment mechanism 20. The rail alignment mechanism 20 utilises a fixture beam 21 to provide a solid rigid structure during operation. Preferably the beam comprises an elongate beam of steel. The beam includes a first and second pair of guide rails 22, 23 on its lower side with a first and further clamping mechanism 24, 25. Each clamping mechanism 24, 25 includes one or more clamps (two shown per mechanism in FIG. 2) 26, 27 together with alignment markers 28, 29 which are arranged to locate with respect to predetermined fixed points on the first rail section 11 and further rail section 12 which are to be secured together at an interface 30 between juxtaposed ends of the adjacent rail sections.

FIG. 3 illustrates a cross sectional view across points A-A in section 2. The rail 11 is shown in cross section having an expanded top section 31, a top surface of which forms a running surface 32 once the rail sections are duly joined and in operation. This bulbous extension 31 is connected to a base 33 by a connecting portion 34. Alignment markers 28 formed, for example, by a plate, extend downwardly from the fixed beam area provide a first and further datum points 35, 36 which are replaceable hardened datum blocks, to align the crown, gauge face and foot of the rail. The lower datum point 35 abuts with an extreme surface of the base of the rail whilst the edge of the alignment plate 28 abuts at datum point 36 with a side surface of the bulbous portion 31 of the top of the rail.

Point 21 shows the fixture beam which will be held by a crane supported from the vehicle. There are two guide rails, one running down both outside edges of the fixture beam. It will be appreciated that a broad range of guidance mechanisms could be utilised according to alternative embodiments of the present invention.

FIG. 4 illustrates the parts of the rail alignment mechanism which are utilised to urge the ends of the adjacent rail sections together. Such urging forces are provided by two substantially parallel spaced apart hydraulic rams 40 with ends of the piston elements 41 of the hydraulic rams being secured to one of the rail elements 12. The hydraulic rams are secured via eccentric Serrated cam arrangement which increases in force as applied load increases. The other ends of the hydraulic rams, including the cylinder element, are secured to the other rail element 11. In this way, as the hydraulic rams are extended the rails are pulled apart whilst when the pistons are drawn into the cylinders hydraulically the rails are urged together under substantial pressure. It will be understood that a pressure with which the rail ends are drawn together will be determined by the manner in which the rams are extended or retracted. Pressure sensors can, of course, be utilised and the elongation of the hydraulic rams controlled so as to maintain a desired pressure during the bonding process.

When a bond is to be prepared between adjacent rail sections, the two lengths of rail are clamped to respective parts of the rail alignment mechanism 20 and pulled into line and together to a set distance. Prior to this it will be appreciated that the ends of the rails which are to be bonded together should be prepared. In this regard the mobile vehicle carries a grinding mechanism able to clean the faces prior to bonding. The grinding mechanism will also act as a smoother surface as it is helpful if the surfaces of the adjacent ends are smooth. This helps improve the strength of a resulting bond. According to embodiments of the present invention, the joint faces may be cleaned so as to remove any traces of rust and oxidation. This again helps improve the strength in the bond. An insert member, such as a foil slice, is then inserted between the rail ends. Preferably the insert is a nickel chromium foil including Silicon and Boron. Again, according to embodiments of the present invention, it is preferable to clean the foil so as to avoid contaminants. It is possible for preformed foil sections to be manufactured off site and transported to the work site under sealed packaged conditions with the package only being opened and foil removed when the rails are to be bonded together. With the rail ends and foil duly located, the lengths of rail are pulled together by the hydraulic system and a holding pressure applied across the bonding interface. A holding pressure of between 2.70 and 2.80 and preferably 2.74 MPa are applied. It will be appreciated that in accordance with embodiments of the present invention as heating of the bond interface occurs, the pressure can be controlled at the bonding interface by providing a bi-directional hold to compensate for any over pressure from rail expansion caused by the heating. The pressure is measured via a suitable monitor.

FIG. 5 illustrates how a heating coil 50 is next located around the interface 30 in which the foil insert 51 is located. It will be appreciated that the coil element can be wound around the work site on site or may be formed from an openable configuration which may be clamped around the bonding interface. According to embodiments of the present invention the coil, when a solid coil, would be loaded over the rail section and would be disposable. A split coil could be reusable. The coil is provided with a power source via the vehicle or some other power source so as to heat the area around the bonding interface via induction coil. The temperature for the bonding process must be above that of the insert of the foil. When an MBF51 insert is utilised a melting point of 1013 to 1126° C. is preferably used. The temperature is measured by a temperature sensor, such as a thermocouple and/or optical pyrometry. It has been found that preferable conditions occur when the temperature of the rail bond is maintained between 1250° C. and 1300° and more preferably at or around 1275°. The foil preferably brings the centre of the rail head up to a temperature which is desired without melting the corners of the feet of the rail and utilises heat conduction as well as the induction heating effects to achieve this aim.

Subsequent to the location of the coil around the bonding interface but prior to heating of the bonding interface, a gas box is formed around the coil. FIG. 6 illustrates the gas box 60 in greater detail which is formed from multiple plate elements 70 (one illustrated in FIG. 7) of various shapes and configurations. As illustrated in FIG. 8, ends of the gas box 60 are formed from two plate elements 80, 81 which have a cut out section having a profile section to match with a cross sectional profile of the rail which is to be bonded. In this way two half box sections 61, 62 may be formed prior to the bonding process and then duly located around the bonding interface. The peripheral edge region 82 around the opening in the ends of the gas box preferably include a sealant which is able to withstand increased temperatures and pressures. It will be understood that the connections for the coil located around the bonding interface will pass through openings (not shown) in a side panel of the gas box. The two sections of box are then secured together in a suitable manner such as by bolting using bolts 83. Subsequent to the box being closed and sealed, the seals may be checked for wear with spare seals being carried on the vehicle in order to replace the seals when there is any evidence of wear. Preferably seals are replaced subsequent to a predetermined number of bondings.

Oxygen is totally or at least partially removed from around the bonding interface according to embodiments of the present invention. This is achieved either by evacuating the chamber formed within the gas box around the bonding interface using an evacuating pump. Alternatively, and more preferably, oxygen is substantially removed from within the chamber region surrounding the bonding interface using a purging process using a neutral gas, such as Argon. Argon gas is sprayed via nozzles through inlet ports 63 in the gas box and pumped out of the gas box via outlet nozzle 64. The argon thus purges the atmosphere of oxygen. Oxygen scavengers, such as titanium, may be employed within the box. The purging of oxygen can be achieved either by purging with argon for a predetermined period of time or by measuring oxygen content continually and establishing that oxygen has been sufficiently removed when the noted data satisfies a predetermined characteristic i.e. when oxygen concentration falls below a desired value.

A cooling system (not shown) may be provided around the exterior of the gas box so as to contain the heating effects within the region proximate to the bonding interface. This helps lengthen the time in service for the various component parts.

Once the atmosphere surrounding the bonding interface is sufficiently free of oxygen, the heating system is activated by supplying power to the heating coil 50 around the bonding interface. The temperature profile is monitored via one or more temperature sensors such as thermocouples. The heating step may be a straight heating profile or there may be a holding step so as to improve homogenisation of the bonding process. Preferably the temperature is held at 1275° C. for 20 minutes. Subsequent to heating, the heating mechanism is deactivated and subsequently the argon purging or vacuum pump is switched off and the atmosphere allowed to drain of argon.

The box housing may then be opened and removed either manually or automatically by the mobile unit. The coil is next removed and either disposed of or opened and removed so as to be reused. Next the rail is released from the clamping and alignment mechanisms and the device may be stowed away and the vehicle is moved to a next join site or a join site at the same work site where a parallel rail join is to be formed.

Preferably the whole process will be recorded via a central control monitor, including one or more camera units 13 so that any faults can be documented or if an accident subsequently occurs a trail may be identified to establish whether or not a join was correctly carried out.

Embodiments of the present invention provide a precise method of heating rail equally across the cross section of the rail within a narrow temperature tolerance. This helps improve overall strength of a bond between adjacent rail sections. Likewise, embodiments of the present invention permit the application and control of bonding pressure across the whole or a substantial part of the whole of the rail face. Again, this provides a good strong bond. In fact it has been found that forming the bond under the above-described conditions provides a surprisingly strong bond having a strength far in excess of what would have been expected by those skilled in the art. This makes the bonding methodology and apparatus particularly applicable to a broad range of welding environments, not just where rail sections are to be bonded together.

Embodiments of the present invention provide a method for accurately clamping and holding the rails to a precise tolerance of alignment which ensures that the rails are bonded in a substantially linear manner. Embodiments of the present invention also provide a method for cutting and finishing the weld faces to an agreed high level of tolerance of surface finish and squareness. Again this helps provide a substantially linear rail formed of multiple rail sections bonded together end-on-end.

Embodiments of the present invention provide the advantage that the whole bonding process may be monitored and recorded. With the use of cameras at a work site the actions of users at that bonding site may be monitored and subsequently stored for future reference. In addition, or alternatively, parameters utilised during the bonding process such as pressure and/or temperature and/or oxygen content may be continuously monitored during the bonding process. Such data can be stored for use later on if the worst should happen and a bond fail.

Embodiments of the present invention provide a mechanism for applying and controlling an inert atmosphere around a bonding interface during a welding process. By ensuring that little or no oxygen and little or no nitrogen is present around the bonding interface, the end result is a bond which is strong and which has a strength and hardness substantially matching the surrounding carbon steel material of the adjacent rail sections. As a result when the rail is put into service as part of a railway the various parts of rail and bonding area will wear at an approximately equal rate. This avoids any development of uneven sections of rail which might otherwise need servicing or which might lead to failure.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. Apparatus for securing a first metallic target object to a further metallic target object, comprising:
a heating element for heating a bonding interface region between juxtaposed portions of a first and further metallic target object;
at least one chamber body portion securable around the interface region to form a chamber region surrounding the interface region;
a pump member for at least partially removing oxygen from the chamber region; and
a target object locating unit arranged to locate portions of the first and further target objects in a juxtaposed position.

2. The apparatus as claimed in claim 1 wherein said first and further target objects comprise a first rail member and a further rail member respectively, the portions of the target objects comprising respective ends of the rail members.

3. The apparatus as claimed in claim 2 wherein said locating unit comprises:
a first locating member for locating an end of the first rail member at a first desired location; and
a second locating member for locating an end of the further rail member at a further location.

4. The apparatus as claimed in claim 2 wherein said locating unit comprises:
a first clamping member removably securable to said first rail member; and
a further clamping member removably securable to said further rail member;
wherein said first and further clamping members are arranged to be urged together to thereby urge the juxtaposed ends of the rails together.

5. The apparatus as claimed in claim 4, further comprising:
at least one hydraulic ram arranged to urge rails held in the clamping members together.

6. The apparatus as claimed in claim 5 wherein the rails are urged together with a pressure between 2.70 and 2.80 MPa.

7. The apparatus as claimed in claim 1, further comprising:
at least one insert element locatable at the bonding interface.

8. The apparatus as claimed in claim 1, further comprising:
the at least one chamber body portion comprises a plurality of plate elements releasably securable together, inner surfaces of the plate elements thereby defining walls for the chamber region.

9. The apparatus as claimed in claim 8, further comprising:
a plurality of end plate elements including cut-out sections having a shape selected to match a cross section of the rails to be bonded together.

10. The apparatus as claimed in claim 9 wherein said plurality of end plate elements each comprise a seal around a peripheral edge region of each cut-out section.

11. The apparatus as claimed in claim 1, wherein said heating element comprises at least one induction coil element and an associated power source, the coil element being locatable proximate to the bonding interface to heat the interface via induction heating.

12. The apparatus as claimed in claim 11 wherein heat generated by the heating element is evenly distributed across a whole surface area of the bonding interface.

13. The apparatus as claimed in claim 11, further comprising:
a temperature controller arranged to maintain the temperature of the bonding interface between 1255° C. and 1300° C.

14. The apparatus as claimed in claim 1, wherein the apparatus is arranged to bond the first and further rail members together with a bond strength equal to or over 710 N/mm² or MPa.

15. The apparatus as claimed in claim 1, wherein said pump member comprises a vacuum pump.

16. The apparatus as claimed in claim 1, further comprising:
at least one gas injector nozzle arranged to inject a shielding gas into said chamber region.

17. The apparatus as claimed in claim 16 wherein the shielding gas is argon.

18. The apparatus as claimed in claim 16 wherein said pump member comprises an extraction pump arranged to pump shielding gas and oxygen from said chamber region.

19. A method for securing a first metallic target object to a further metallic target object, comprising the steps of:
inserting an insert element at a bonding interface between juxtaposed portions of first and second metallic target objects;
applying pressure to said bonding interface;
at least partially removing oxygen from a region surrounding said bonding interface; and
heating said region to thereby secure said target objects via a diffusion bonding process.

20. The method as claimed in claim 19 wherein said first and further target objects comprise a first rail member and a further rail member respectively, the portions of the target objects comprising respective ends of the rail members.

21. The method as claimed in claim 20, further comprising the steps of:
removing oxygen from said region by locating plate elements around said bonding interface, securing said elements together at a desired location with respect to said interface and evacuating a chamber region formed by said wall elements.

22. The method as claimed in claim 20 further comprising the steps of:
removing oxygen from said region by locating plate elements around said bonding interface, securing said elements together at a desired location with respect to said interface and flushing the chamber with a shielding gas prior to bonding.

23. The method as claimed in claim 22 further comprising the steps of pumping shielding gas and oxygen from the chamber.

24. The method as claimed in claim 19, further comprising the steps of:
prior to at least partial removal of oxygen from said region, forming a seal between wall elements and said first and second rail members.

25. (canceled)

26. (canceled)
